(19) United States
(12) Patent Application Publication
(10) Pub. No.: US 2017/0167907 A1
(43) Pub. Date: Jun. 15, 2017

(54) FLUID REGULATION SYSTEM

(71) Applicant: Charles A. Hair, Temecula, CA (US)

(72) Inventor: Charles A. Hair, Temecula, CA (US)

(21) Appl. No.: 15/379,436

(22) Filed: Dec. 14, 2016

Related U.S. Application Data
(60) Provisional application No. 62/266,875, filed on Dec. 14, 2015.

(51) Int. Cl. G01F 9/00; G01F 1/66

(52) U.S. Cl. CPC G01F 9/008; G01F 1/66

(57) ABSTRACT

The disclosed technology includes a method comprising detecting one or both of a rate of normal water flow and a duration of normal water flow, and calculating a maximum rate of normal water flow and a maximum duration of normal water flow. In another implementation, the method also includes calculating a minimum rate of normal water flow and a minimum duration of normal water flow. In yet another implementation, the method also includes monitoring one or both of a rate of current water flow and a duration of current water flow, determining whether a predetermined threshold is met, and adjusting a valve to close if the predetermined threshold is met.

### CROSS-REFERENCES TO RELATED APPLICATIONS (IF ANY)

This application claims the priority date of Provisional Application No. 62/266,875 filed on Dec. 14, 2015.

### BACKGROUND

A water main leak or break can occur in a water line for various reasons, including damage, wear and tear of the water line, a previously ill-repaired water line, and changes in temperature. Leaks and breaks in water lines can lead to extensive damage in residential and commercial buildings. If undetected, a water main leak or break can cause catastrophic damage in a building, as well as lead to water waste

There is still room for improvement in the art.

### SUMMARY OF THE INVENTION

The disclosed technology includes a method comprising detecting one or both of a rate of normal water flow and a duration of normal water flow, and calculating a maximum rate of normal water flow and a maximum duration of normal water flow. In another implementation, the method also includes calculating a minimum rate of normal water flow and a minimum duration of normal water flow. In yet another implementation, the method also includes monitoring one or both of a rate of current water flow and a duration of current water flow, determining whether a predetermined threshold is met, and triggering a valve to adjust if the predetermined threshold is met.

This Summary is provided to introduce a selection of concepts in a simplified form that are further described below in the Detailed Description. Other implementations are also described and recited herein. This Summary is not intended to identify key features or essential features of the claimed subject matter, nor is it intended to be used to limit the scope of the claimed subject matter. These and various other features and advantages will be apparent from a reading of the following Detailed Description.

### BRIEF DESCRIPTION OF THE DRAWINGS

Without restricting the full scope of this invention, the preferred form of this invention is illustrated in the following drawings:

FIG. 1 is an example fluid regulation system;

FIG. 2 shows example operations for calculating a maximum rate of normal water flow and a maximum duration of normal water flow; and

FIG. 3 shows example operations for regulating water flow in a water regulation system.

### DESCRIPTION OF THE PREFERRED EMBODIMENT

There are a number of significant design features and improvements incorporated within the invention.

Details are set forth in order to provide a thorough understanding of the present invention. It will be apparent, however, to one skilled in the art that the present invention may be practiced without some of these specific details. For example, while various features are ascribed to particular implementations, it should be appreciated that the features described with respect to one implementation may be incorporated with other implementations as well. Similarly, however, no single feature or features of any described implementation should be considered essential to the invention, as other implementations of the invention may omit such features.

Toilets, sinks, and other appliances or containers may receive a fluid supply, such as water, from a source via a pipe or conduit. Over time, pipes or conduits can fail. For example, a conduit such as a house water line connected to a toilet can leak or break. The leak or break can be attributed to wear and tear of the water line, inadequate repair to a previously damaged water line, or due to temperature change. If a user is present at the time of failure, the user can turn off the water source via a main water line, or the user can adjust an angled stop connected to the water line located between a wall and a toilet. If the user is not present, catastrophic damage can occur to a dwelling, in addition to water waste.

The disclosed technology includes methods and an apparatus for fluid regulation. Specifically, the fluid is regulated by measuring current water flow, detecting normal water flow, and calculating maximum water flow. A “normal” water flow can be defined as a predetermined rate or duration or a consistent value determined by a learning module for acceptable use. In another implementation, the disclosed technology also includes monitoring water flow, and adjusting a valve if a predetermined threshold is met.

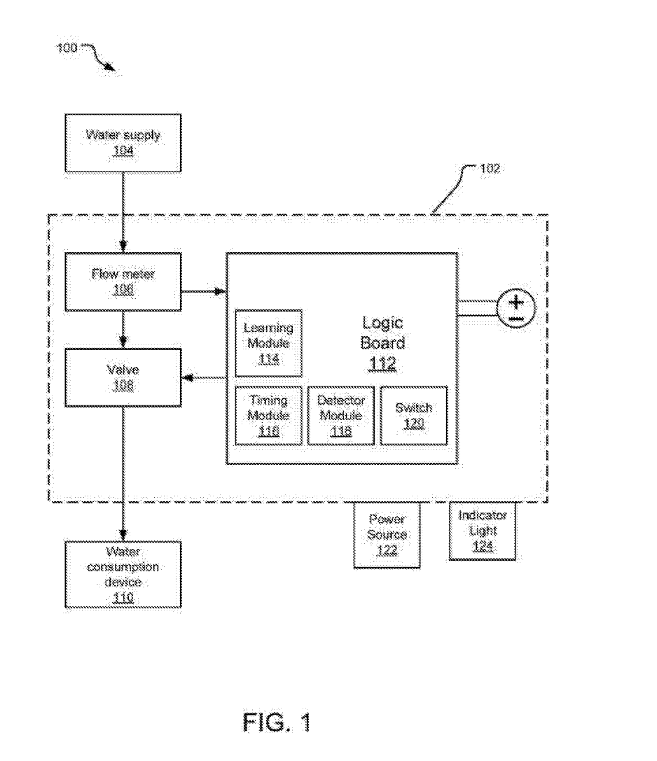

FIG. 1 is an example fluid regulation system 100. As shown, the fluid regulation system 100 can include different components. These components can be housed together, as depicted in an outlined fluid regulation apparatus or housing 102, or the components can be housed separately in multiple housings or apparatus.

The fluid regulation apparatus 102 can vary in size and materials, and house different components, such as connectors, depending on the fluid regulation application. There may be connectors on the side of the fluid regulation apparatus 102 (not shown). The connectors facilitate fluid flow in and out of the fluid regulation apparatus 102. For example, if the fluid regulation system 100 is directed toward regulating water in a water line to a toilet, the connectors on a housing 102 will be configured for attachment to a water supply 104 (e.g., a water line) and/or a water consumption device 110 (e.g., a toilet, a sink, other various devices, containers, reservoirs, or conduits, etc.). In another implementation, the fluid supply could be tailored to oil, gas, or another fluid, and the connectors could be applicable to housings supplying and containing those fluids.

In FIG. 1, the components of the fluid regulation apparatus 102 include a flow meter 106, a valve 108, and a printed circuit board or logic board 112. Connectors and piping (not shown) fluidly connect the components of the fluid regulation system 100.

The flow meter 106 connects to the water supply 104 and to the logic board 112. The flow meter 106 measures the flow of the fluid, such as water, flowing from the water supply 104, and communicates flow measurements to the logic board 112. In some implementations, the measurements include the rate of current water flow and the duration of current water flow.

The valve 108 can be located in between the flow meter 106 and a water consumption device or component 110 (as shown in FIG. 1), in between the water supply 104 and the flow meter 106, or in another location where the valve 108 can adjust, open, or close and control fluid flow. The valve 108 (e.g., a solenoid valve) may have a propeller assembly and/or other components.

Depending on the fluid flow measurements, the logic board 112 can communicate to the valve 108 to open, adjust, or close to facilitate fluid regulation from the water supply 104 to the water consumption component 110.

The logic board 112 receives fluid flow measurements from the flow meter 106, and a detector module 118 located in the logic board 112 detects one or both of a rate of normal water flow and a duration of normal water flow.

A learning module 114 calculates a maximum rate of normal water flow and a maximum duration of normal water flow. By detecting one or both of a rate of normal water flow and a duration of normal water flow and calculating a maximum rate of normal water flow and a maximum duration of normal water flow, the fluid regulation apparatus 102 learns via the learning module 114 how much fluid should be flowing through a conduit or pipe in a fluid regulation system 100 at any given time.

In another implementation, the disclosed apparatus and methods also include the fluid regulation apparatus 102 monitoring one or both of a rate of current water flow and a duration of current water flow, and adjusting a valve to open or close if a threshold is met. Examples of these scenarios may include a pipe break or other damage or malfunctioning upstream from the flow meter 106 from the water supply 104, resulting in increased or decreased water flow.

In one implementation, meeting a threshold can mean exceeding a maximum rate of water flow and a maximum duration of water flow. For example, the threshold may be met when a predetermined maximum volume is exceeded, such as a predetermined volume of water in a toilet bowl flush. If the flow meter 106 measures 2.3 gallons of water has flowed through the flow meter 106 at a certain rate for one flush, the learning module 114 determines that the maximum rate of flow water (e.g., 1.6 gallons) for a toilet may be exceeded. In yet another example, the threshold could mean exceeding a predetermined volume per a maximum time interval, such as a 45-second toilet flush. A timing module 116 in the logic board 112 measures time intervals for the water flow.

In some implementations, some of the parameters, such as the rate or duration of water flow, can be predetermined. In such cases, the fluid regulation apparatus 102 is tailored to the specifications during manufacturing or adjusted by a user via an interface on the fluid regulation apparatus 102.

In another implementation, the disclosed method may include detecting one or both of a rate of normal water flow and a duration of normal water flow, calculating one or both of a minimum rate of water flow and a minimum duration of water flow, monitoring one or both of the current rate of water flow and current duration of water flow, and determining if a threshold is met. In one example, the threshold is met when the flow meter 106 measures 0.2 gallons of water flowing through the flow meter 106 at a certain rate, and the learning module 114 determines that the flow of water (e.g., 1.6 gallons) for a certain toilet falls below the minimum rate. In yet another example, the threshold means falling below a predetermined volume per a minimum time interval, such as a 45-second toilet flush. Examples of these scenarios may be if there is a break in a water pipe upstream from the flow meter 106.

Once the logic board 112 determines that a threshold is met, the logic board signals the valve 108 to open, adjust, or close. For example, if the predetermined threshold is met and the water flow in a fluid regulation system has exceeded a maximum, then the logic board 112 signals the valve 108 to close. In another example, if the predetermined threshold is met and the water flow in a fluid regulation system has fallen below a minimum, then the logic board 112 signals the valve 108 to open. Or, in another example, if the predetermined threshold is met and the water flow in a fluid regulation system has exceeded a maximum threshold or fallen below a minimum threshold, the logic board 112 sends signals to communicate the status of the fluid regulation system 100 to an interface (not shown).

The interface can be located on the fluid regulation apparatus 102, or located on a separate device. The fluid regulation apparatus 102 may run automatically or may be operated manually via a switch 120 in the logic board 112. The fluid regulation apparatus may also have an indicator light 124. The indicator light 124 can be located on the exterior of the fluid regulation apparatus 102. The indicator light 124 may indicate power supply levels, different operations of the disclosed methods, warning signals, and other communicable features. The indicator light 124 can signal in different modes, colors, brightness, other means, etc., which facilitate communication regarding the fluid regulation system 100. For example, after powering on the fluid regulation apparatus 102, and initiating water flow measurements and detection, an LED indicator light can turn an orange color (e.g., during a calibration or learning module operation). The learning module operation can be a timed operation via a timing module 116, or based on other criteria such as reaching a number of consistent data points. Once the learning module operation has completed, the indicator light 124 may turn a blinking green color to indicate a calculating operation, and turn to a solid green, non-blinking color once the calculating operation has completed. In other implementations, the features described here may be indicated on a separate interface or device, or communicated in text or other message form.

The fluid regulation apparatus 102 has a power source 122 (e.g., a 9-volt battery). The power source can be attached to the logic board (as shown in FIG. 1) or attached to other components or housing. In some implementations, there may be more than one power source 122.

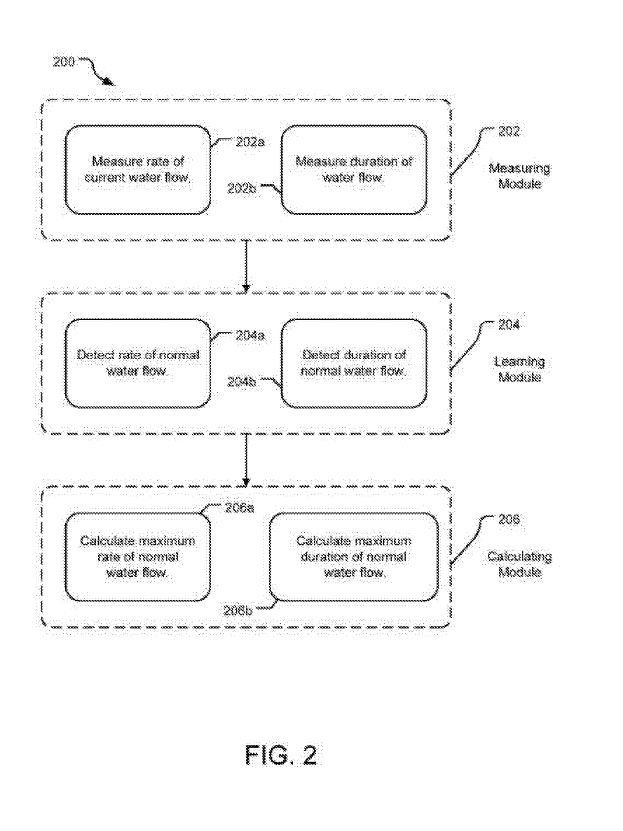

FIG. 2 shows example operations 200 for calculating a maximum rate of normal water flow and a maximum duration of normal water flow. A flow meter measures current water flow in a measuring module 202. Specifically, the flow meter measures one or both of two parameters. The flow meter can measure a rate of current water flow in an operation 202a and a duration of current water flow in an operation 202b. The flow meter communicates the current water flow measurements to a logic board.

The logic board receives the measurements from the flow meter, and a learning module 204 located in the logic board detects one or both of a rate of normal water flow in an operation 204a and a duration of normal water flow in an operation 204b.

A calculating module 206 is a module that calculates maximum water flow in the logic board. Within the calculating module 206, an operation 206a calculates a maximum rate of normal water flow. Within the calculating module 206, an operation 206b calculates a maximum duration of normal water flow.

By detecting one or both of a rate of normal water flow and a duration of normal water flow and calculating a maximum rate of normal water flow and a maximum duration of normal water flow, the fluid regulation apparatus learns via the learning module how much fluid should be flowing through a conduit or pipe in a fluid regulation system at any given time

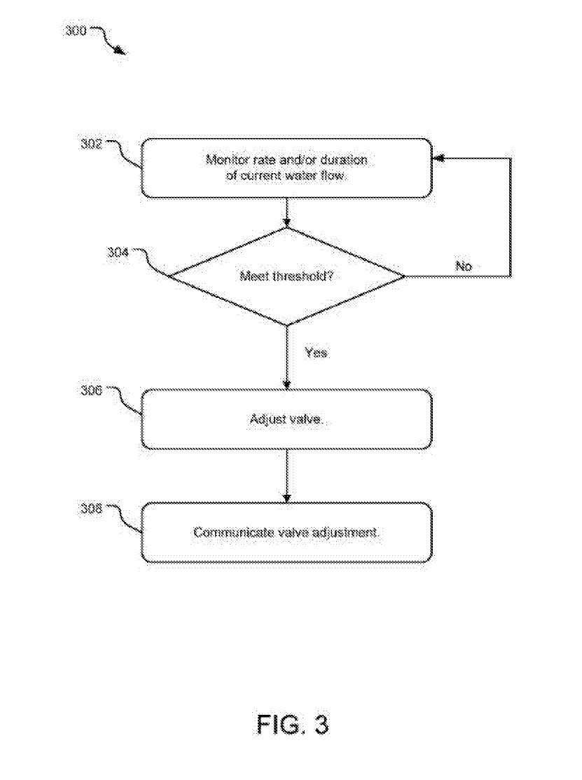

FIG. 3 shows example operations 300 for regulating water flow in a water regulation system by monitoring one or both of a rate of current water flow and a duration of current water flow, and adjusting a valve to open or close if a threshold is met. Examples of these scenarios may include a pipe break or other damage or malfunctioning upstream from the flow meter resulting in increased or decreased water flow.

An operation 302 monitors one or both of a rate and a duration of current water flow. A determining operation 304 determines whether or not a threshold is met. In one implementation, meeting a threshold can mean exceeding a maximum rate of water flow and a maximum duration of water flow. For example, the threshold may be met when a predetermined maximum volume is exceeded, such as a predetermined volume of water in a toilet bowl flush. If the flow meter measures 2.3 gallons of water flowing through the flow meter at a certain rate, the learning module determines that the maximum rate of water flow (e.g., 1.6 gallons) for a certain toilet may be exceeded. In yet another example, the threshold could mean exceeding a predetermined volume per a maximum time interval, such as a 45 second toilet flush.

In another implementation, the disclosed methods may include detecting one or both of a rate of normal water flow and a duration of normal water flow, calculating one or both of a minimum rate of water flow and a minimum duration of water flow, monitoring one or both of the current rate of water flow and current duration of water flow, and determining if a threshold is met. The threshold could be met when the flow meter measures 0.2 gallons of water flowing through the flow meter at a certain rate, and the learning module determines that the flow of water (e.g., 1.6 gallons) for a certain toilet falls below the minimum rate. In yet another example, the threshold could mean falling below a predetermined volume per a minimum time interval, such as a 45 second toilet flush. Examples of these scenarios may include a break in a water pipe upstream from the flow meter.

Once the logic board determines that a threshold is met, the logic board signals the valve to adjust (e.g., open or close). If the threshold is met, then an adjusting operation 306 adjusts a valve to increase or decrease water flow.

For example, if the predetermined threshold is met and the water flow in a fluid regulation system has exceeded a maximum, then the logic board signals the valve to close. In another example, if the predetermined threshold is met and the water flow in a fluid regulation system has fallen below a minimum, then the logic board signals the valve to open. Or, in another example, if the predetermined threshold is met and the water flow in a fluid regulation system has exceeded a maximum or fallen below a minimum, the logic board sends signals to communicate the status of the fluid regulation system to an interface.

A communicating operation 308 communicates the valve adjustment. In some implementations, a communicating operation can alert a user of water flow measurements via a display, an interface, or other electronic communications

In some implementations, adjusting operation 306 does not occur and after determining operation 304 occurs, communicating operation 308 immediately occurs next.

The operations 306-308 can occur sequentially or simultaneously. For example, communicating the valve opening or closure in communicating operation 308 can occur at the same time that the valve is opening or closing in adjusting operation 306.

The described methods and apparatus may be used in a variety of fluid regulation applications. The examples provided include toilet water flow regulation. The methods and apparatus may be used with respect to showers, sinks, clothes washers, refrigerators, urinals, or other appliances or devices.

The above specification, examples, and data provide a complete description of the structure and use of exemplary embodiments of the disclosed technology. Since many embodiments of the disclosed technology can be made without departing from the spirit and scope of the disclosed technology, the disclosed technology resides in the claims hereinafter appended.

Furthermore, structural features of the different embodiments may be combined in yet another embodiment without departing from the recited claims

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A method comprising:
Measuring one or both of a rate of current water flow and a duration of current water flow;
detecting one or both of a rate of normal water flow and a duration of normal water flow; and
calculating a maximum rate of normal water flow and a maximum duration of normal water flow.

2. A charging device according to claim 1 further comprising:
monitoring one or both of a rate of current water flow and a duration of current water flow;
determining whether a predetermined threshold is met; and adjusting a valve to close if the predetermined threshold is met.

3. The method of claim 1, further comprising calculating a minimum rate of normal water flow and a minimum duration of normal water flow

4. The method of claim 3, further comprising adjusting the valve to open if the predetermined threshold is met.

5. The method of claim 1, further comprising communicating if the predetermined threshold is met.

6. The method of claim 1, further comprising communicating valve adjustment via a communication device.

7. The method of claim 1, wherein the detecting operation detects the rate of normal water flow for a toilet flush cycle.

8. The method of claim 7, wherein the calculating operation calculates a maximum rate based on the water volume in a toilet flush cycle.

9. The method of claim 1, wherein the detecting operation detects the duration of normal water flow for a toilet flush cycle.

10. The method of claim 9, wherein the calculating operation calculates a maximum duration based on a determined length of time for one toilet flush cycle.

11. A method comprising:
measuring one or both of a rate of current water flow and a duration of current water flow;
detecting one or both of a rate of normal water flow and a duration of normal water flow;
calculating a maximum rate of normal water flow and a maximum duration of normal water flow;
calculating a minimum rate of normal water flow and a minimum duration of normal water flow;
monitoring one or both of a rate of current water flow and a duration of current water flow;
determining whether a predetermined threshold is met; and communicating a predetermined threshold is met.

12. The method of claim 11, further comprising adjusting a valve to open or close when the predetermined threshold is met.

13. The method of claim 11, wherein the detecting operation detects the rate of normal water flow for a toilet flush cycle.

14. The method of claim 11, wherein the detecting operation detects the duration of normal water flow for a toilet flush cycle.

15. A fluid regulation apparatus, comprising:
a valve;
a flow meter configured to measure one or both of a rate of current water flow and a duration of current water flow; and
a printed circuit board configured to detect one or both of a rate of normal water flow and a duration of normal water flow and calculate one or both of a maximum rate of normal water flow and a maximum duration of normal water flow.

16. The fluid regulation apparatus of claim 15, wherein the printed circuit board is further configured to monitor one or both of a current rate of water flow and a current duration of water flow, determine if a predetermined threshold is met, and adjust the valve to close if the maximum rate of current water flow or maximum duration of current water flow is exceeded.

17. The fluid regulation apparatus of claim 15, wherein the printed circuit board is further configured to detect one or both of a rate of normal water flow and a duration of normal water flow and calculate one or both of a minimum rate of normal water flow and a minimum duration of normal water flow.

18. The fluid regulation apparatus of claim 17, wherein the printed circuit board is further configured to monitor one or both of a current rate of water flow and a current duration of water flow, determine if a predetermined threshold is met, and adjust the valve to open if the water flow falls below a minimum rate of current water flow or minimum duration of current water flow.

19. The fluid regulation apparatus of claim 15, further comprising a communication device configured to communicate operations performed via the printed circuit board.

20. The fluid regulation apparatus of claim 19, wherein the communication device is an interface.
